(19) United States
(12) Patent Application Publication
(10) Pub. No.: US 2011/0256418 A1
(43) Pub. Date: Oct. 20, 2011

(54) ASSEMBLY FOR PREVENTING GALVANIC CORROSION AND METHOD OF ASSEMBLING SAME

(75) Inventors: Michael P. McGowan, Sterling Heights, MI (US); Scott S. Moore, Royal Oak, MI (US); Nicholas M. Bosway, Clarkston, MI (US)

(73) Assignee: GM GLOBAL TECHNOLOGY OPERATIONS, INC., DETROIT, MI (US)

(21) Appl. No.: 12/762,629

(22) Filed: Apr. 19, 2010

(51) Int. Cl. B32B 15/01; B32B 3/10; C25D 13/00; B32B 3/00

(52) U.S. Cl. 428/594; 428/172; 428/137; 204/471

(57) ABSTRACT

An assembly for limiting corrosion between a first member made of a first material and a second member made of a second material, different from the first material, includes a plurality of cylindrical dimples defined in the first member. The cylindrical dimples are formed as a one-piece structure with the first member. The cylindrical dimples and the second member interact to define a plurality of galvanic contact zones. An electrocoat covers substantially all of the first member and the second member, but does not cover the galvanic contact zones. Therefore, the galvanic contact zones are not in contact with the electrocoat and are sealed to prevent contact with an electrolyte. A method of assembling a first member to a second member, to limit corrosion therebetween, is also provided.

### TECHNICAL FIELD

This disclosure relates generally to features for coupling dissimilar materials while limiting or preventing corrosion, such as galvanic corrosion.

### BACKGROUND

Many components and assemblies—including those within vehicles—are coupled together from dissimilar materials. Electrochemically-dissimilar materials placed into electrically-conductive contact may undergo corrosion in the presence of an electrolyte. Direct contact may be prevented by insulation materials placed between the electrochemically-dissimilar materials. Insulation may prevent electrical conduction and the corrosion resulting therefrom.

### SUMMARY

An assembly for limiting corrosion between a first member made of a first material and a second member made of a second material, different from the first material, is provided herein. The assembly includes a plurality of cylindrical dimples defined in the first member. The plurality of cylindrical dimples are formed as a single, contiguous, one-piece structure with the first member.

The plurality of cylindrical dimples and the second member interact to define a plurality of galvanic contact zones. The assembly also includes an electrocoat, which covers substantially all of the first member and the second member. However, the electrocoat does not cover, at least, the plurality of galvanic contact zones. Therefore, the plurality of galvanic contact zones are not in contact with the electrocoat and are sealed to prevent contact with an electrolyte.

A method of assembling a first member to a second member is also provided. The method limits corrosion between the first and second members, and includes: A) stamping a first hole in the first member; B) stamping a plurality of cylindrical dimples in the first member; C) attaching the first member to the second member, wherein the first member is attached to the second member with a fastener, forming a coupled assembly; and D) electrocoating the coupled assembly, such that substantially all exposed surfaces of the first member, the second member, and the fastener are covered by an electrocoat.

The above features and advantages, and other features and advantages, of the present invention are readily apparent from the following detailed description of some of the best modes and other embodiments for carrying out the invention when taken in connection with the accompanying drawings.

### BRIEF DESCRIPTION OF THE DRAWINGS

FIG. 1 is a schematic isometric view of an assembly for limiting corrosion between a first member a second member made of dissimilar materials;

FIG. 2 is a schematic isometric view of only the first and second members of the assembly shown in FIG. 1;

FIG. 3 is a schematic isometric cross-sectional view of the assembly shown in FIG. 1 taken along line 3-3; and

FIG. 4 is a schematic more detailed view of area 4-4 of FIG. 3, showing an electrocoat covering much of the assembly.

### DETAILED DESCRIPTION

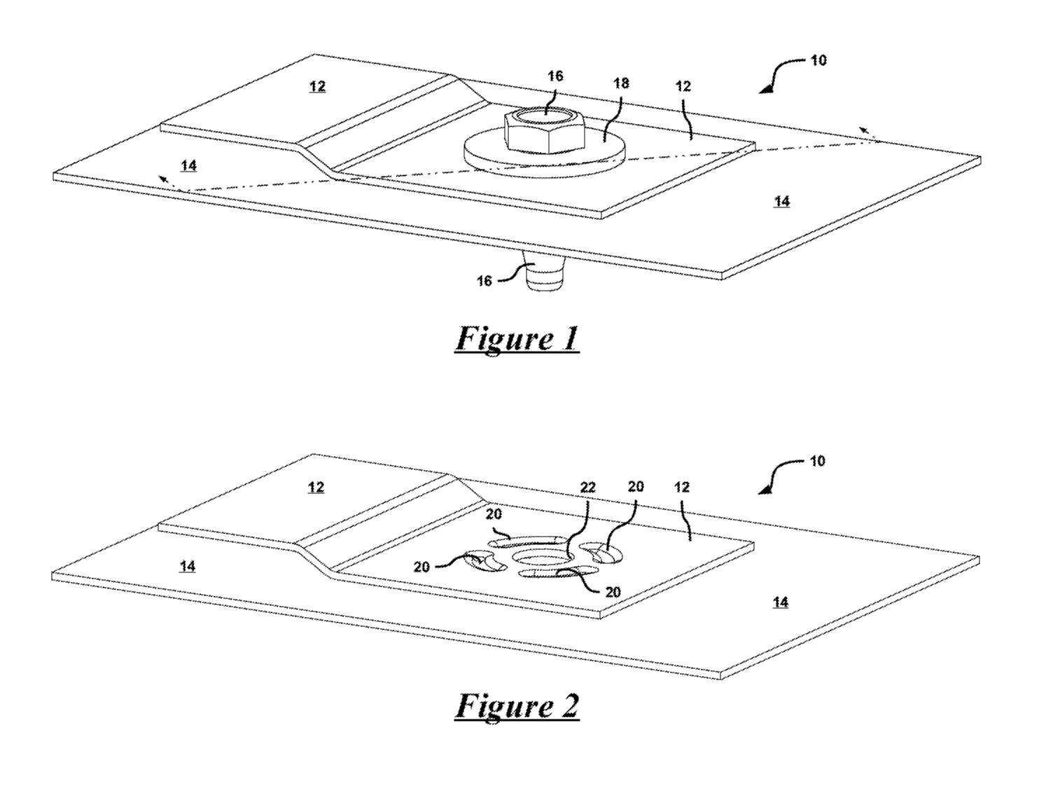

Referring to the drawings, wherein like reference numbers correspond to like or similar components throughout the several figures, there is shown in FIG. 1 an isometric view of an assembly 10 having a first member 12 and a second member 14. The first member 12 is made of a first material and the second member 14 is made of a second material different from the first material, such that the assembly 10 has at least two dissimilar materials.

The first member 12 may be, for example and without limitation, a fender, a portion of a fender, or a similar structure on a vehicle. Therefore, the first member 12 shown in FIG. 1 may be only a small portion of a much larger component. The second member 14 may be, for example and without limitation, a frame or a portion of a frame for a vehicle. Similarly, the second member 14 shown in FIG. 1 may be only a small portion of a much larger component.

While much of the present invention is described in detail with respect to automotive applications, those skilled in the art will recognize the broader applicability of the invention. Those having ordinary skill in the art will also recognize that terms such as “above,” “below,” “upward,” “downward,” et cetera, are used descriptively of the figures, and do not represent limitations on the scope of the invention, as defined by the appended claims.

A fastener 16 attaches the first member 12 to the second member 14. The fastener 16 may be a bolt, a screw, a rivet, or another component recognizable to those having ordinary skill in the art as capable of, and suitable for, coupling or clamping the first member 12 to the second member 14. The specific size and type of the fastener 16 will depend on the size and loading conditions of the assembly 10.

In the illustrative assembly 10 shown in FIG. 1, the fastener 16 cooperates with a washer 18. In the configuration shown, the washer 18 is disposed intermediate the first member 12 and the head of the fastener 16. Alternatively, the washer 18 may be located elsewhere. Furthermore, the washer 18 may be incorporated or formed as a part of the fastener 16. The fastener 16 and washer 18 may also be formed as an assembly, such that the washer 18 is captive to the fastener 16.

The assembly 10 may be formed from numerous dissimilar materials. Illustrative materials include aluminum and steel. For example, and without limitation, if the first member 12 is an automotive fender and the second member 14 an automotive frame, the first material may be aluminum and the second material may be steel. Alternatively, the first material may be steel and the second material may be aluminum.

When two electrochemically-dissimilar materials (often metals) are present, corrosion may occur under some conditions. Aluminum and steel are electrochemically-dissimilar materials, either of which may be used in the first member 12 or the second member 14. This type of corrosion may be referred to as galvanic corrosion or dissimilar metal corrosion, and is the process by which one, or both, of the materials in contact with each other oxidize or corrode.

Corrosion may occur when there is an electrically-conductive path between the two materials, and where the two materials are in the presence of an electrolyte. An electrically-conductive path often occurs where the two materials are in direct contact, but may occur in other situations. Electrolytes include water, especially when salts or other minerals are dissolved in the water—such as with seawater or rain and snow runoff in regions utilizing salt on roadways.

Where the two dissimilar materials are clamped together, small amounts of moisture may wick into very small gaps between the materials. Moisture may be trapped or may sit between the gaps for an extended period of time. This establishes, at least temporarily, a galvanic cell as the electrolyte provides a means for ion migration whereby ions can move from one material (the anode) to the other material (the cathode).

Referring now to FIG. 2, and with continued reference to FIG. 1, there is shown another isometric view of a portion of the assembly 10. In the view shown in FIG. 2, only the first member 12 and the second member 14 are shown. With the washer 18 removed or removed from view, FIG. 2 shows structures configured to limit galvanic corrosion between the first member 12 and the second member 14 (made from electrochemically-dissimilar materials). The first member 12 includes a plurality of cylindrical dimples 20 which extend from the first member 12 to, and make contact with, the second member 14.

The cylindrical dimples 20 are formed as a one-piece structure with the first member 12. In the illustrative assembly 10 shown in the figures, the cylindrical dimples 20 are formed in the first member 12. However, the cylindrical dimples 20 may be formed on either the first member 12 or the second member 14. The corrosive properties (or lack thereof) are substantially the same whether the cylindrical dimples 20 are formed on the first member 12 or the second member 14.

A first hole 22 is also defined in the first member 12. The fastener 16 (not shown in FIG. 2, shown in FIG. 1) passes through the first hole 22. The cylindrical dimples 20 are substantially symmetric about the first hole 22. In FIG. 2, the cylindrical dimples 20 are formed curving around, or rounded about, the first hole 22 (i.e. the cylinders are bent or arcing with the first hole 22 at the center of the arc). However, the cylindrical dimples 20 could be formed as straight cylindrical impressions (i.e. more like a true cylinder) and still be symmetrically spaced or disposed about the first hole 22 in a pattern suggestive of a square.

FIG. 2 shows the first member 12 having four cylindrical dimples 20 symmetrically spaced about the first hole 22. However, other configurations may include two, three, or greater numbers of cylindrical dimples 20. If three, arced cylindrical dimples 20 are formed into first member 12, the shape would look very similar to that shown in FIG. 2, except that the spacing and proportions of the cylindrical dimples 20 may be different. If, however, three straight cylindrical dimples 20 are formed into the first member 12, the cylindrical dimples 20 would form a triangle pattern with the first hole 22 at the center of the triangle pattern.

Referring now to FIG. 3, and with continued reference to FIGS. 1 and 2, there is shown an isometric cross-sectional view of the assembly 10 shown in FIG. 1. The cross-sectional view shown in FIG. 3 was taken along line 3-3 of FIG. 1. FIG. 3 shows the interface areas coupling the dissimilar materials of the first member 12 and the second member 14.

In addition to passing through the first hole 22 in the first member 12, the fastener 16 passes through a second hole 24 in the second member 14. The fastener 16 cooperates with a receptacle or a weld nut 26 to provide clamping force to the first member 12 and the second member 14. The interior of the weld nut 26 and the exterior of the adjoining portion of the fastener 16 may be threaded.

The second member 14 includes a face area 30 that cooperates with the cylindrical dimples 20 to define a plurality of galvanic contact zones 32. The face area 30 may be substantially planar (as shown in FIGS. 1-3) or may be slightly concave or convex. However, the actual contacts between the first member 12 and the second member 14 occur only in the galvanic contact zones 32. The galvanic contact zones 32 provide a potential electrically-conductive path between the first member 12 and the second member 14. In the illustrative assembly 10 shown in FIGS. 1-3, there are four cylindrical dimples 20 and four galvanic contact zones 32.

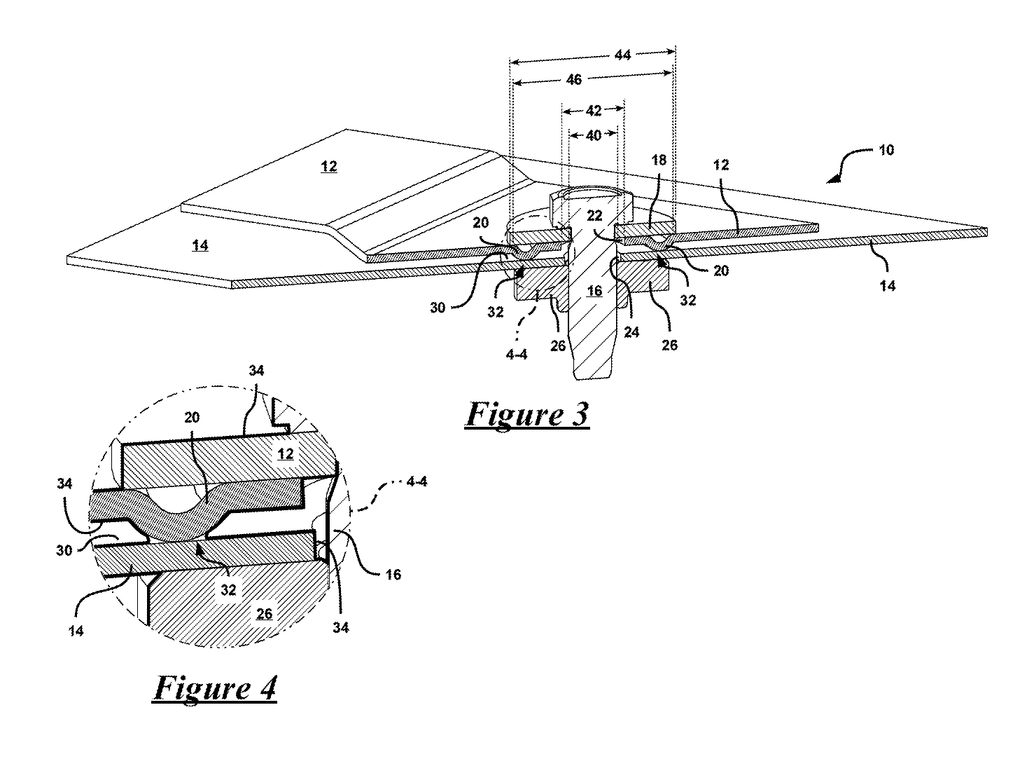

Referring now to FIG. 4, and with continued reference to FIGS. 1-3, there is shown a more detailed view of the isometric cross-sectional view shown in FIG. 3. The more detailed view shown in FIG. 4 is taken at region 4-4 of FIG. 3. FIG. 4 shows one of the galvanic contact zones 32 where the cylindrical dimples 20 of the first member 12 contact the face area 30 of the second member 14.

After attachment of the first member 12 to the second member 14 with the fastener 16—and, possibly, following attachment of other components—the whole assembly 10 has an electrocoat 34 applied. The electrocoat 34 is shown in FIG. 4 as a thick, dark line where the cross section line 3-3 intersects surfaces covered with the electrocoat 34. The electrocoat 34 may also be referred to as, for example: E-coat, e-coat, electrophoresis or electrophoretic coating, electrodip, electropaint, electrodeposition or electrodeposition process.

The electrophoretic coating process or electrocoating process by which the electrocoat 34 is applied is an organic coating method that uses electrical current to deposit water-based paint or coatings onto metal or conductive parts. The electrocoat 34 may be applied as a first coat of paint, a primer coat, as a final coat of paint, or solely as a protective layer for prevention galvanic corrosion. Because the electrocoat 34 is applied in a liquid environment—such as a dip or bath—most surfaces subjected to the liquid will have a layer of the electrocoat 34. The electrocoat 34 may undergo additional curing or finishing processes.

The electrocoat 34 covers substantially all of the first member 12 and the second member 14 except for the galvanic contact zones 32. Therefore, the galvanic contact zones 32 are not in contact with the electrocoat 34 but are surrounded by the electrocoat 34. The galvanic contact zones 32 are sealed or insulated to prevent contact with any electrolyte interacting with the first member 12 and the second member 14.

The electrocoat 34 is illustrative as a thick, bold line and may not be shown to scale in FIG. 4. Therefore, the electrocoat 34 may be substantially thinner or substantially thicker relative to the other components shown. Depending upon the thickness of the electrocoat 34 and the size of the other components of assembly 10, the electrocoat 34 may be viewable in from the viewpoint of FIG. 3 for some embodiments of assembly 10 (though the electrocoat 34 is not viewable in the illustrative assembly 10 shown in the FIG. 3 herein).

As shown in FIG. 4, the galvanic contact zone 32 maintains a small interface between the cylindrical dimples 20 and the face area 30 which does not have the electrocoat 34 applied thereto. The electrocoat 34 does not reach all the way to the contact areas between the cylindrical dimples 20 and the face area 30, and forms a rounded edge opposite the galvanic contact zones 32. The electrocoat 34 and the shape of the dimples 20 cause electrolytes, such as water, to wick away from the galvanic contact zones 32. Without prolonged contact with an electrolyte, galvanic corrosion between the first member 12 and the second member 14 may be substantially limited or prevented.

Referring again to FIG. 3, the fastener 16 has a fastener diameter 40, and the first hole 22 has a hole diameter 42. The hole diameter 42 is larger than the fastener diameter 40, such that the electrocoat 34 may be disposed intermediate the fastener 16 and the first hole 22. Furthermore, contact between the first member 12 and the fastener 16 is prevented by the hole diameter 42 being larger than the fastener diameter 40. The larger size of the hole diameter 42 limits galvanic corrosion of the first member 12.

The cylindrical dimples 20 may be formed by stamping the first member 12. The cylindrical dimples 20 and first hole 22 may be stamped together, as part of forming the first member 12. For example, and without limitation, if the first member 12 is an automotive fender, the cylindrical dimples 20 and first hole 22 may be stamped during the forming process for the fender itself.

The washer 18 has a washer diameter 44 and the cylindrical dimples 20 have an outer diameter 46. In the illustrative example shown in FIGS. 1-4, the outer diameter 46 of the cylindrical dimples 20 is smaller than the washer diameter 44. The relative size of the outer diameter 46 of the cylindrical dimples 20 and the washer diameter 44 controls load distribution between the washer 18 and the cylindrical dimples 20.

The assembly 10 shown in FIGS. 1-4 may be a portion of a fender and a frame on a vehicle. A method of assembling the fender to the frame is also described herein. The fender may be manufactured from either the first member 12 or the second member 14 before assembling it to the frame, which is made from the other of the first member 12 and the second member 14. While the method is illustrated and described with respect to much of the structure shown in FIGS. 1-4, those having ordinary skill in the art will recognize that other components may be used within the scope of the claimed method.

Manufacturing and assembly of the fender may include stamping the first hole 22 and the cylindrical dimples 20 into the fender. The fender is then attached to the frame—such as with the fastener 16—forming a frame-fender assembly (part of which may be the assembly 10 shown in the figures). Next, the frame-fender assembly 10 may be electrocoated, such that substantially all of the fender and the frame are covered by an electrocoat 34.

The cylindrical dimples 20 may be stamped in a symmetric pattern about the first hole 22 in the fender. Furthermore, the first hole 22 and the cylindrical dimples 20 in the fender may be stamped in a single stamping process.

The method may also include placing the washer 18 between the fastener 16 and the fender prior to forming the assembly 10. The washer 18 may also be assembled with the washer diameter 44 being larger than an outer diameter 46 of the cylindrical dimples 20. The fender may be formed from aluminum and the frame may be formed from steel.

While some of the best modes and other embodiments for carrying out the claimed invention have been described in detail, those familiar with the art to which the invention relates will recognize various alternative designs and embodiments for practicing the invention defined in the appended claims.

1. An assembly for limiting corrosion between a first member made of a first material and a second member made of a second material different from the first material, the assembly comprising:
a plurality of cylindrical dimples, wherein the plurality of cylindrical dimples are defined in the first member, and the plurality of cylindrical dimples are formed as a one-piece structure with the first member;
wherein the plurality of cylindrical dimples and the second member interact to define a plurality of galvanic contact zones; and
an electrocoat covering substantially all of the first member and the second member except for the plurality of galvanic contact zones, such that the plurality of galvanic contact zones are not in contact with the electrocoat and are sealed to prevent contact with an electrolyte.

2. The assembly of claim 1,
wherein the first member defines a first hole; and
wherein the plurality of cylindrical dimples are substantially symmetric about the first hole.

3. The assembly of claim 2,
wherein a fastener attaches the first member to the second member, and has a fastener diameter; and
wherein the first hole has a hole diameter larger than the fastener diameter, such that the electrocoat is disposed intermediate the fastener and the first hole.

4. The assembly of claim 3, wherein the plurality of cylindrical dimples are formed by stamping the first member.

5. The assembly of claim 4,
wherein the fastener cooperates with a washer having a washer diameter;
wherein the washer is in contact with the first member; and
wherein the plurality of cylindrical dimples have an outer diameter smaller than the washer diameter.

6. The assembly of claim 5,
wherein the first material is aluminum; and
wherein the second material is steel.

7. The assembly of claim 1,
wherein the first member defines a first hole;
wherein a fastener attaches the first member to the second member, and has a fastener diameter; and
wherein the first hole has a hole diameter larger than the fastener diameter, such that the fastener is not in contact with the first member.

8. The assembly of claim 7,
wherein the fastener cooperates with a washer having a washer diameter;
wherein the washer is in contact with the first member; and
wherein the plurality of cylindrical dimples have an outer diameter smaller than the washer diameter.

9. The assembly of claim 8, wherein the plurality of cylindrical dimples are substantially symmetric about the first hole.

10. A method of assembling a first member to a second member, comprising:
stamping a first hole in the first member;
stamping a plurality of cylindrical dimples in the first member;
attaching the first member to the second member, wherein the first member is attached to the second member with a fastener, forming a coupled assembly; and
electrocoating the coupled assembly, such that substantially all exposed surfaces of the first member, the second member, and the fastener are covered by an electrocoat.

11. The method of claim 10, further comprising:
forming the first member from a first material; and
forming the second member from a second material different from the first material.

12. The method of claim 11, wherein the plurality of cylindrical dimples are stamped in a symmetric pattern about the first hole in the first member.

13. The method of claim 12, wherein stamping the first hole in the first member and stamping the plurality of cylindrical dimples in the first member occurs in a single stamping process.

14. The method of claim 13, wherein a plurality of contact zones between the plurality of cylindrical dimples and the second member are not covered by the electrocoat during electrocoating of the coupled assembly.

15. The method of claim 14, further comprising:
placing a washer between the fastener and the first member prior to forming the assembly; and
wherein the washer has a washer diameter larger than an outer diameter of the plurality of cylindrical dimples.

16. The method of claim 15, wherein the first material is aluminum and the second material is steel.
